(19) United States
(12) Patent Application Publication
(10) Pub. No.: US 2017/0309005 A1
(43) Pub. Date: Oct. 26, 2017

(54) METHOD OF AND SYSTEM FOR GENERATING SIMPLIFIED BORDERS OF GRAPHICAL OBJECTS

(71) Applicant: YANDEX EUROPE AG, Luzern (CH)

(72) Inventor: Anton Vasilyevich KORZUNOV, Podolsk, Moscow region (RU)

(21) Appl. No.: 15/531,516

(22) PCT Filed: Feb. 4, 2016
(86) PCT No.: PCT/IB16/50576

§ 371 Date: May 30, 2017

(30) Foreign Application Priority Data
Sep. 28, 2015 (RU) 2015141092

(51) Int. Cl. G06T 5/30; G06F 17/11; H04N 19/85

(52) U.S. Cl. CPC G06T 5/30; H04N 19/85; G06F 17/11

(57) ABSTRACT

A computing device and method for generating a simplified first border of a first graphical object and a simplified second border of a second graphical object, the first and the second original borders comprising respective original border portions, the method comprising: receiving instruction to generate the simplified first border and the simplified second border; detecting that the first original border portion and the second original border portion are located in close proximity within a predetermined maximal distance; selecting a first point and a second point being located respectively on the first and on the second original border portions; generating the simplified first and the second borders by applying a single simplification rule both to the first and to the second original border portions, such that: the first point is located on the first simplified border portion, and the second point is located on the second simplified border portion.

### CROSS-REFERENCE

The present application claims priority to Russian Patent Application No 2015141092, filed Sep. 28, 2015, entitled “METHOD OF AND SYSTEM FOR GENERATING SIMPLIFIED BORDERS OF GRAPHICAL OBJECTS” the entirety of which is incorporated herein.

### FIELD OF THE TECHNOLOGY

The present technology relates to method and system for generating simplified borders of graphical objects.

### BACKGROUND

In computer technologies, use of graphical objects is widespread. Graphical objects are used in graphic design, in computer games, in map services, and in many other areas. Computer readable storages of computing devices (both personal devices and other devices, such as servers of service providers) can store plenty of graphical objects, both two-dimensional and three dimensional. Information about graphical objects can be used to generate a visual representation of the graphical objects, or to transfer the graphical objects to another device, or for other purposes.

Often, there is a need for simplifying borders of graphical objects. There could be many reasons, such as, for example, decreasing the volume of transferred data, or to adapting to the processing capacity of a video card, or the need to show the objects in smaller details, like when zooming out in a map service.

Several graphical objects can be located in close proximity to each other. Since simplifying borders of graphical objects causes their deformation, it is possible that several non-overlapping graphical objects, being simplified, become overlapping which is undesirable.

### SUMMARY

It is thus an object of the present technology to ameliorate at least some of the inconveniences present in the prior art.

In one aspect, implementations of the present technology provide a method for generating a simplified first border of a first graphical object and a simplified second border of a second graphical object. Both the first graphical object and the second graphical object have respectively a first original border and a second original border. The first original border and the second original border are defined by their respective coordinates. The first original border comprises a first original border portion. The second original border comprises a second original border portion. The method is executable on a computing device. The method comprises: receiving instruction to generate the simplified first border and the simplified second border; detecting, by comparing coordinates of the first graphical object and the second graphical object, that the first original border portion and the second original border portion are located in close proximity within a predetermined maximal distance; selecting a first point and a second point, the first point being located on the first original border portion and the second point being located on the second original border portion; generating the simplified first border and the simplified second border comprising correspondingly a first simplified border portion and a second simplified border portion, by applying a single simplification rule both to the first original border portion and to the second original border portion, such that: the first point is located on the first simplified border portion, and the second point is located on the second simplified border portion.

In some implementations, selecting the first point and the second point is performed such that a distance between the first point and the second point is a shortest distance between the first original border portion and the second original border portion.

In some implementations, the first original border portion comprises two extreme points defining a beginning and an end of the first original border portion, and the second original border portion comprises two extreme points defining a beginning and an end of the second original border portion; and wherein selecting the first point and the second point is performed such that: the first point is an extreme point of the first original border portion defining the beginning of the first original border portion; and the second point is an extreme point of the second original border portion defining the beginning of the second original border portion; and the first point and the second point are located one in front of another, such that if all four extreme points consisting of two extreme points of the first original border portion defining the beginning and the end of the first original border portion and two extreme points of the second original border portion defining the beginning and the end of the second original border portion, are connected by imaginary straight edges, an imaginary straight edge connecting the first point and the second point is not crossed by any other one of said imaginary straight edges.

In some implementations, the method further comprises: selecting a third point and a fourth point, the third point being located on the first original border portion and the four point being located on the second original border portion, wherein: (i) selecting the first point and the third point is performed such that the first point and the third point are extreme points of the first original border portion defining a beginning and the end of the first original border portion, and (ii) selecting the second point and the fourth point is executed such that the second point and the fourth point are extreme points of the second original border portion defining a beginning and an end of the second original border portion; and wherein: generating the simplified first border and the simplified second border comprising correspondingly the first simplified border portion and the second simplified border portion, is performed such that: the first point and the third point are located on the first simplified border portion, and the second point and the fourth point are located on the second simplified border portion.

In some implementations, the first original border portion comprises sections consecutively connecting plurality of vertexes of the first original border portion, the second original border portion comprises sections consecutively connecting plurality of vertexes of the second original border portion; and wherein the single simplification rule comprises reducing number of vertexes of the first original border portion and number of vertexes of the second original border portion.

In some implementations, the computing device is any one, selected from: a server, and a client device.

In some implementations, the computing device is a server, the method further comprising sending, to a client device, an instruction to display the at least part of the simplified first border and the at least part of the simplified second border on a display screen of the client device.

In some implementations, the instruction to display the at least part of the simplified first border and the at least part of the simplified second border on a display screen of the client device comprises an instruction to zoom a visual presentation of the at least part of the simplified first border and the at least part of the simplified second border.

In some implementations, the computing device is a client device, the method further comprising rendering the at least part of the simplified first border and the at least part of the simplified second border on a display screen of the client device.

In some implementations, rendering the at least part of the simplified first border and the at least part of the simplified second border on the display screen of the client device is rendering scaled visual presentation of the at least part of the simplified first border and the at least part of the simplified second border.

In some implementations, the first graphical object and the second graphical object are three-dimensional objects, and wherein the first original border portion and the second original border portion are curving surfaces.

In yet another aspect, implementations of the present technology provide a computing device for generating a simplified first border of a first graphical object and a simplified second border of a second graphical object. Both the first graphical object and the second graphical object have respectively a first original border and a second original border. The first original border and the second original border are defined by their respective coordinates. The first original border comprises a first original border portion. The second original border comprises a second original border portion. The computing device comprises a processor. The computing device comprises an information storage medium. The information storage medium stores instructions that, when executed by the processor, configure the computing device to: receive instruction to generate the simplified first border and the simplified second border; detect, by comparing coordinates of the first graphical object and the second graphical object, that a first original border portion and a second original border portion are located in close proximity within a predetermined maximal distance; select a first point and a second point, the first point being located on the first original border portion, and the second point being located on the second original border portion; generate the simplified first border and the simplified second border comprising correspondingly a first simplified border portion and a second simplified border portion, by applying a single simplification rule both to the first original border portion and to the second original border portion, such that: the first point is located on the first simplified border portion, and the second point is located on the second simplified border portion.

In some embodiments of the computing device, selecting the first point and the second point is performed such that a distance between the first point and the second point is a shortest distance between the first original border portion and the second original border portion.

In some embodiments of the computing device, the first original border portion comprises two extreme points defining a beginning and an end of the first original border portion, and the second original border portion comprises two extreme points defining a beginning and an end of the second original border portion; and selecting the first point and the second point is performed such that: the first point is an extreme point of the first original border portion define the beginning of the first original border portion, and the second point is an extreme point of the second original border portion define the beginning of the second original border portion, and the first point and the second point are located one in front of another, such that if all four extreme points consisting of two extreme points of the first original border portion define the beginning and the end of the first original border portion and two extreme points of the second original border portion define the beginning and the end of the second original border portion, are connected by imaginary straight edges, an imaginary straight edge connect the first point and the second point is not crossed by any other one of said imaginary straight edges.

In some embodiments of the computing device, the instructions further configure the server to: select a third point and a fourth point, the third point being located on the first original border portion and the four point being located on the second original border portion, wherein: (i) selecting the first point and the third point is performed such that the first point and the third point are extreme points of the first original border portion defining a beginning and the end of the first original border portion, and (ii) selecting the second point and the fourth point is executed such that the second point and the fourth point are extreme points of the second original border portion defining a beginning and an end of the second original border portion; and: generating the simplified first border and the simplified second border comprising correspondingly the first simplified border portion and the second simplified border portion, is performed such that: the first point and the third point are located on the first simplified border portion, and the second point and the fourth point are located on the second simplified border portion.

In some embodiments of the computing device, the first original border portion comprises sections consecutively connect plurality of vertexes of the first original border portion, the second original border portion comprises sections consecutively connecting plurality of vertexes of the second original border portion; and the single simplification rule comprises reducing number of vertexes of the first original border portion and number of vertexes of the second original border portion.

In some embodiments of the computing device, the computing device is any one, selected from: a server, and a client device.

In some embodiments of the computing device, the computing device is a server, and the instructions further configure the server to send, to a client device, an instruction to display the at least part of the simplified first border and the at least part of the simplified second border on a display screen of the client device.

In some embodiments of the computing device, the instruction to display the at least part of the simplified first border and the at least part of the simplified second border on a display screen of the client device comprises an instruction to zoom a visual presentation of the at least part of the simplified first border and the at least part of the simplified second border.

In some embodiments of the computing device, the computing device is a client device, and the instructions further configure the client device to render the at least part of the simplified first border and the at least part of the simplified second border on a display screen of the client device.

In some embodiments of the computing device, rendering the at least part of the simplified first border and the at least part of the simplified second border on the display screen of the client device is rendering scaled visual presentation of the at least part of the simplified first border and the at least part of the simplified second border.

In some embodiments of the computing device, the first graphical object and the second graphical object are three-dimensional objects, and wherein the first original border portion and the second original border portion are curving surfaces.

In the context of the present specification, unless specifically provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless specifically provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless specifically provided otherwise, the word “coordinates” serves to define the position of points, and/or lines, or the like, by references. References can be, for example, numbers and/or any other symbols that are used to determine the position of a point, line (including a curve), or plane in a space of a given dimension with respect to a system of lines (axes) or other fixed references.

In the context of the present specification, unless specifically provided otherwise, the expression “information” includes information of any nature or kind whatsoever, comprising information capable of being stored in a database. Thus information includes, but is not limited to data (map data, location data, coordinates, numerical data, etc.), audiovisual works (photos, movies, sound records, presentations etc.), text (opinions, comments, questions, messages, etc.), documents, spreadsheets, etc.

In the context of the present specification, unless specifically provided otherwise, the expression “component” is meant to include software (appropriate to a particular hardware context) that is both necessary and sufficient to achieve the specific function(s) being referenced.

In the context of the present specification, unless specifically provided otherwise, the expression “information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless specifically provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first point” and “third point” is not intended to imply any particular order, type, chronology, hierarchy or ranking (for example) of/between the points, nor is their use (by itself) intended imply that any “second point” must necessarily exist in any given situation. Further, as is discussed herein in other contexts, reference to a “first” element and a “second” element does not preclude the two elements from being the same actual real-world element. Thus, for example, in some instances, a “first” element and a “second” element may be the same element, in other cases they may be different elements.

In the context of the present specification, unless specifically provided otherwise, the expression “graphical object” is intended to mean any graphical figure which can be displayed on a computer screen (or other audio-vide output means). Graphical objects can be linear objects, two-dimensional objects, and three-dimensional objects. Graphical objects can be of any shape. Borders of graphical objects can be straight or curving lines or straight or curving surfaces, depending on the graphical object.

In the context of the present specification, unless specifically provided otherwise, the expression “border of a graphical object” is intended to mean a perimeter or a portion of the perimeter of a graphical object, wherein the word “perimeter” means a path that surrounds a graphical object. A border of a graphical object can comprise border portions, which border portions can be stored as lines, connecting two extreme points of respective perimeter portion.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram of a system implemented in accordance with an embodiment of the present technology.

FIG. 2 depicts a non-limiting example of a first graphical object and a second graphical object being two-dimensional graphical objects being implemented in accordance with non-limiting embodiments of the present technology.

FIG. 3 depicts alternative non-limiting implementation of a first graphical object and a second graphical object being two-dimensional polygonal graphical objects being implemented in accordance with non-limiting embodiments of the present technology.

FIG. 4 depicts a non-limiting example of the first graphical object and the second graphical object of FIG. 2, with additional information, all being implemented in accordance with non-limiting embodiments of the present technology.

FIG. 5 depicts a non-limiting example of a first graphical object and a second graphical object being three-dimensional graphical objects being implemented in accordance with non-limiting embodiments of the present technology.

FIG. 6 depicts alternative non-limiting example of a first graphical object and a second graphical object being two three-dimensional graphical objects being implemented in accordance with non-limiting embodiments of the present technology.

FIG. 7 depicts a non-limiting example of the first graphical object and the second graphical object of FIG. 2 and schematic illustration of an approach to determining beginnings and ends of border portions, wherein the first graphical object and the second graphical object being implemented in accordance with non-limiting embodiments of the present technology.

FIG. 8 depicts a block-diagram of a computer-implemented method for generating a simplified first border of a first two-dimensional graphical object and a simplified second border of a second two-dimensional graphical object, the method being non-limiting example of the present technology.

FIG. 9 depicts a block-diagram of an alternative computer-implemented method for generating a simplified first border of a first two-dimensional graphical object and a simplified second border of a second two-dimensional graphical object, the method being non-limiting example of the present technology.

FIG. 10 depicts a block-diagram of a computer-implemented method for generating a simplified first border of a first three-dimensional graphical object and a simplified second border of a second three-dimensional graphical object, the method being non-limiting example of the present technology.

### DETAILED DESCRIPTION

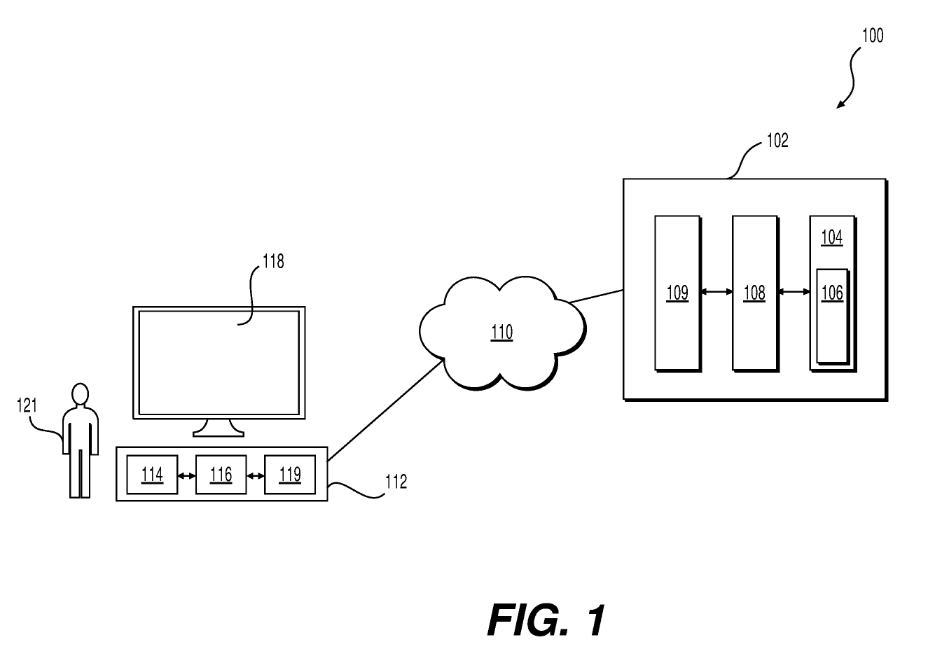

Referring to FIG. 1, there is shown a diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

System 100 includes a computing device being a server 102. The server 102 may be implemented as a conventional computer server. In an example of an embodiment of the present technology, the server 102 may be implemented as a Dell™ PowerEdge™ Server running the Microsoft™ Windows Server™ operating system. Needless to say, the server 102 may be implemented in any other suitable hardware and/or software and/or firmware or a combination thereof. In the depicted non-limiting embodiment of present technology, the server 102 is a single server. In alternative non-limiting embodiments of the present technology, the functionality of the server 102 may be distributed and may be implemented via multiple servers.

In some implementations of the present technology, the server 102 can be under control and/or management of a map service provider, for example, provider of Maps.Yandex™. In alternative implementations the server 102 can access the map service provided by a third-party provider. In yet other implementations, the server 102 can be under control and/or management of provider of such services as computer game services, graphical design services, and other services related to computer graphics.

The server 102 includes an information storage medium 104 that may be used by the server 102. Generally, the information storage medium 104 may be implemented as a medium of any nature and kind whatsoever, including RAM, ROM, disks (CD-ROMs, DVDs, floppy disks, hard drivers, etc.), USB keys, solid state-drives, tape drives, etc. and also the combinations thereof.

The implementations of the server 102 are well known in the art. So, suffice it to state, that the server 102 comprises inter alia a network communication interface 109 (such as a modem, a network card and the like) for two-way communication over a communication network 110; and a processor 108 coupled to the network communication interface 109 and the information storage medium 104, the processor 108 being configured to execute various routines, including those described herein below. To that end the processor 108 may have access to computer readable instructions stored on the information storage medium 104, which instructions, when executed, cause the processor 108 to execute the various routines described herein.

In some non-limiting embodiments of the present technology, the communication network 110 can be implemented as the Internet. In other embodiments of the present technology, the communication network 110 can be implemented differently, such as any wide-area communication network, local-area communication network, a private communication network and so on.

The information storage medium 104 is configured to store data, including computer-readable instructions and other data, including graphical objects data of any kind. In some implementations of the present technology, the information storage medium 104 can store at least part of the data in a database 106. In other implementations of the present technology, the information storage medium 104 can store at least part of the data in any collections of data other than databases.

The information storage medium 104 can store computer-readable instructions that manage control, updates, populating and modifications of the database 106 and/or other collections of data. More specifically, computer-readable instructions stored on the information storage medium 104 cause the server 102 to receive (to update) information in respect of graphical objects (for example, via the communication network 110), to store information in respect of the graphical objects, including the information in respect of their respective perimeters in the database 106, and/or in other collections of data.

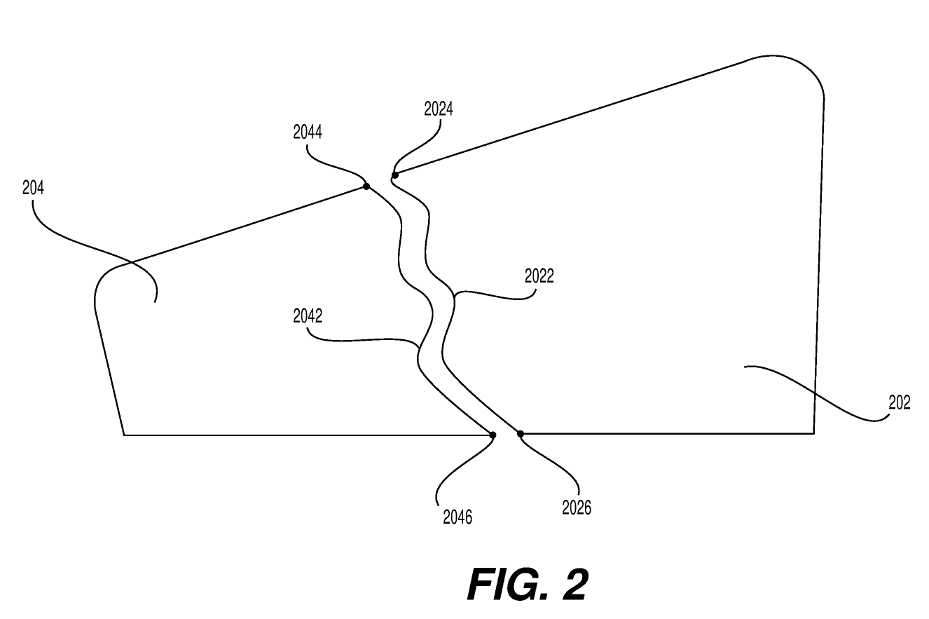

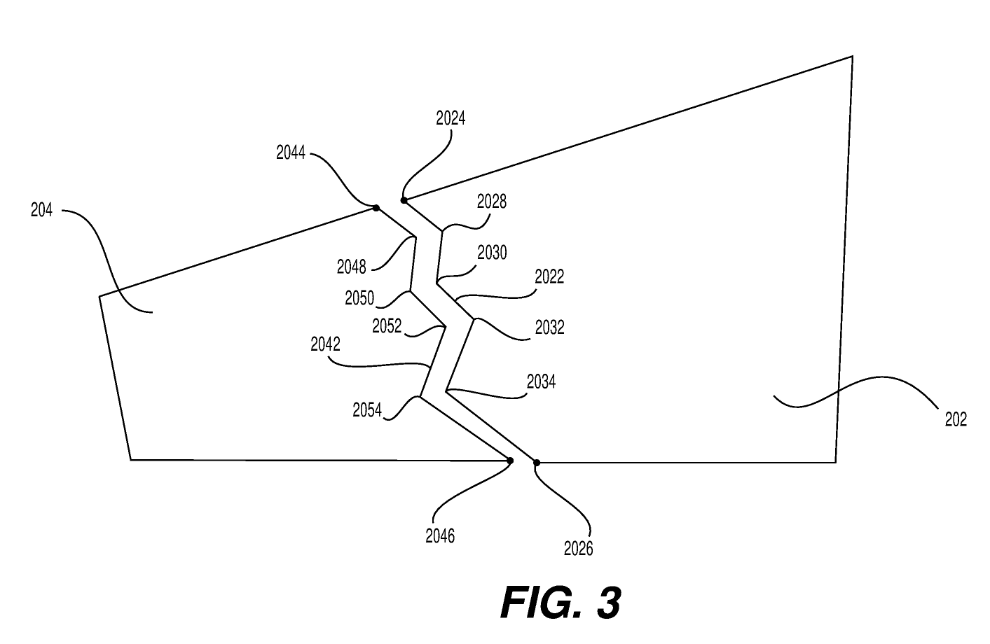

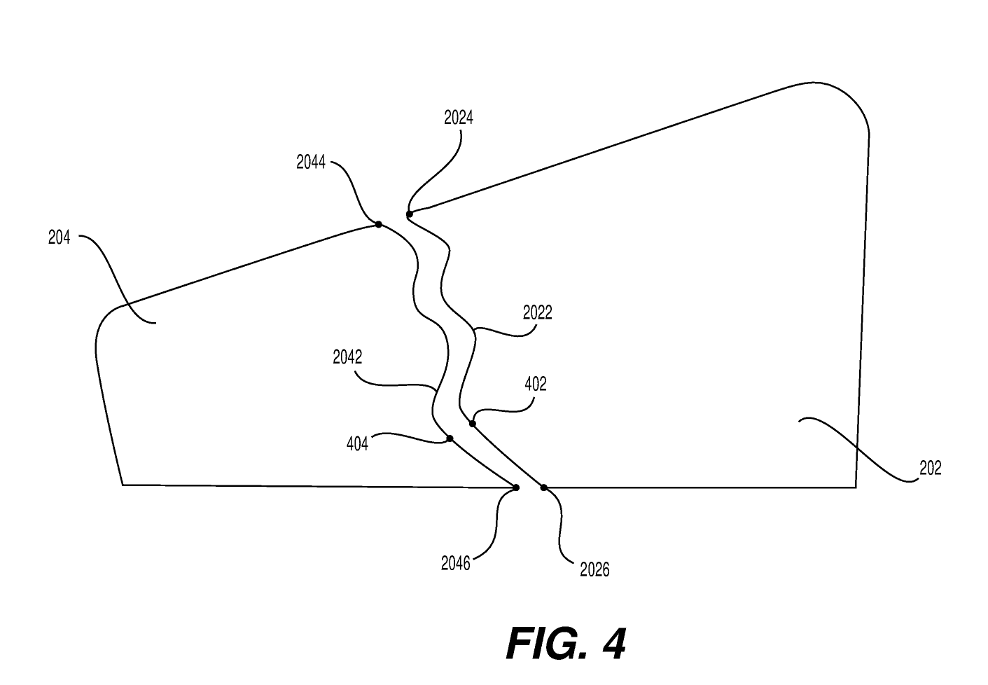

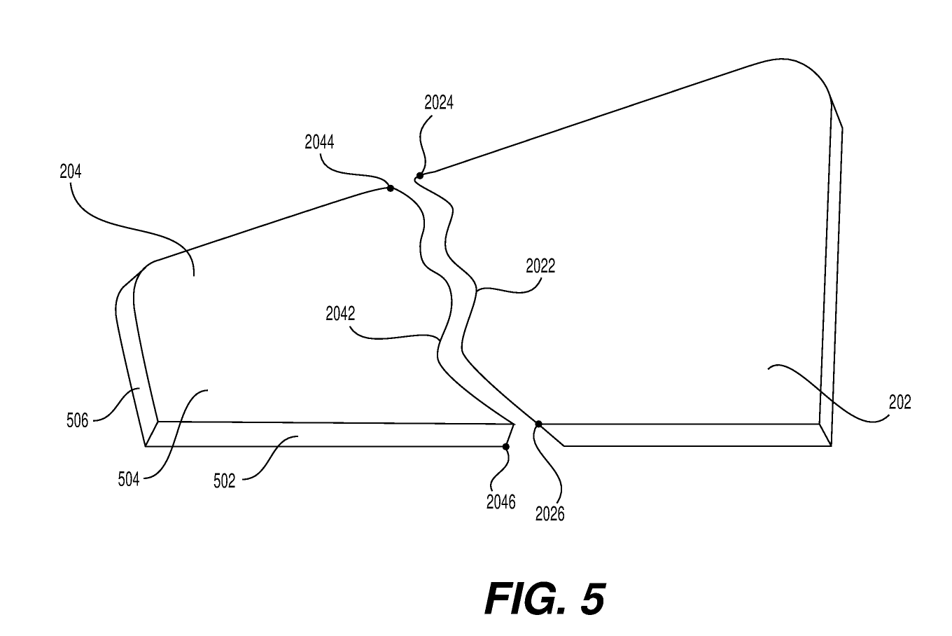

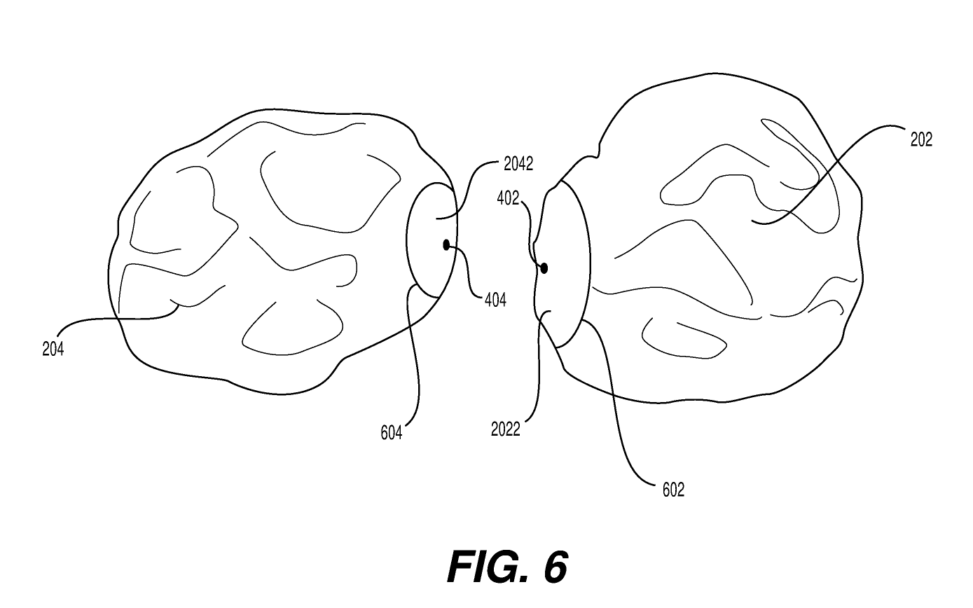

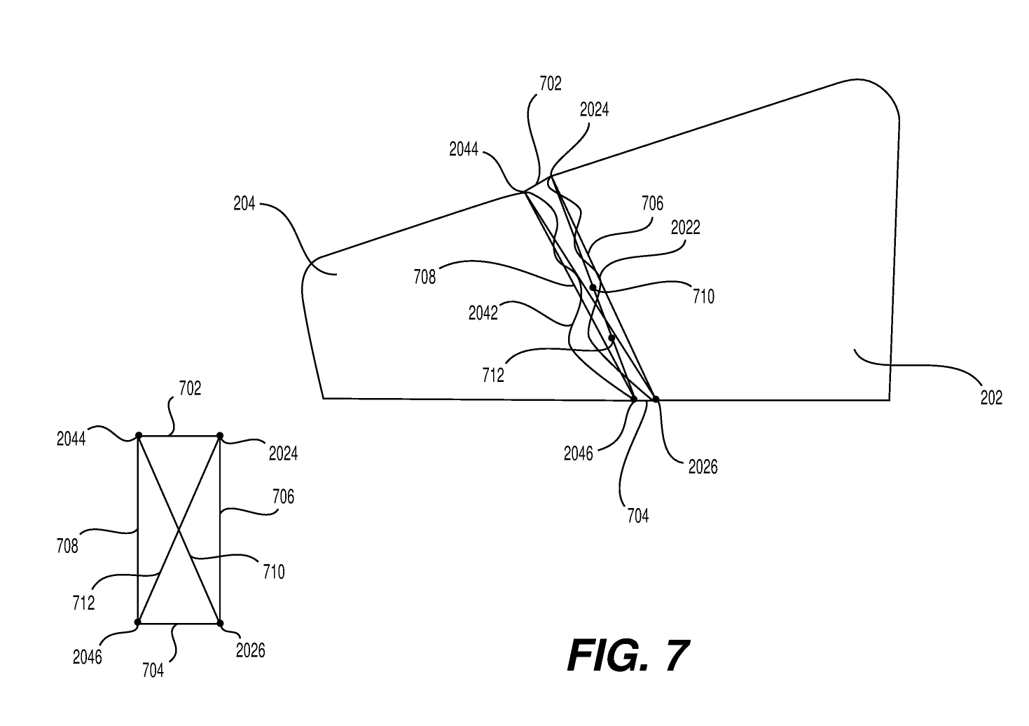

Data stored on the information storage medium 104 (and more particularly, at least in part, in some implementations, in the database 106) can comprise graphical objects of any kind. Non-limiting examples of graphical objects are depicted in FIG. 2, FIG. 3, FIG. 4, FIG. 5, FIG. 6, and FIG. 7.

FIG. 2 illustrates a non-limiting example of a first graphical object 202 and a second graphical object 204 which coordinates are stored on the information storage medium 104. The first graphical object 202 and the second graphical object 204 are depicted as they could be potentially shown on a display screen 118 of a client device 112, which display screen 118 and the client device 112 will be described below in more details. In this non-limiting implementation, the first graphical object 202 and the second graphical object 204 are two two-dimensional graphical objects. The first graphical object 202 and the second graphical object 204 have respectively a first original border (not numbered) and a second original border (not numbered). The first original border and the second original border are defined by their respective coordinates which define positions of points and lines in the two-dimensional space with respect to a system of axis (not depicted). The first original border and the second original border comprise straight lines and curving lines. However, it is not mandatory, and original borders of other two-dimensional objects can comprise either straight lines only (see, for example, FIG. 3), or curving lines only. In some implementations (for example, in the cases where two-dimensional objects are raster images), respective original borders can fully or partially be formed by lines formed by pluralities of points.

The first original border comprises a first original border portion 2022 being a curving line, defined by its coordinates, starting from a first point 2024 determining a beginning of the first original border portion 2022, and ending by a third point 2026 determining an end of the first original border portion 2022.

The second original border comprises a second original border portion 2042 being a curving line, defined by its coordinates, starting from a second point 2044 determining a beginning of the second original border portion 2042, and ending by a fourth point 2046 determining an end of the second original border portion 2042.

The first original border portion 2022 and second original border portion 2042, being in this implementation the curving lines, can comprise plurality of vertexes, being in this implementation local extreme points of curvatures. Plurality of vertexes of the first original border portion 2022 and second original border portion 2042 are not marked and numbered in FIG. 2 for purpose of ease of perception of FIG. 2. However, vertexes of the first original border portion 2022 and second original border portion 2042 will be marked, numbered and described in details below in regard to graphical objects depicted in FIG. 3.

The first original border portion 2022 and the second original border portion 2042 are located in close proximity within a predetermined maximal distance. It means that if the predetermined maximal distance is, for example, 1 millimeter, the first point 2024 is disposed 1 millimeter away from the second point 2044, the third point 2026 is disposed 1 millimeter away from the fourth point 2046, and all other points located on the first original border portion 2022 are located not further that 1 millimeter from the closest point located on the second original border portion 2042. It should be understood that the predetermined maximal distance may vary in different implementations of the present technology and may be expressed in any suitable values, such as in metrical system, in system of imperial units, in pixels, etc.

FIG. 3 illustrates alternative non-limiting implementation of a first graphical object 202 and a second graphical object 204 which coordinates are stored on the information storage medium 104. The first graphical object 202 and the second graphical object 204 are depicted as they could be potentially shown on the display screen 118. In this non-limiting implementation, the first graphical object 202 and the second graphical object 204 are two two-dimensional polygonal graphical objects. The first graphical object 202 and the second graphical object 204 have respectively a first original border (not numbered) and a second original border (not numbered). The first original border and the second original border are defined by their respective coordinates which define positions of points and lines by references being numbers which determine the position of points and lines in the two-dimensional space with respect to a system of axes (not depicted). The first original border and the second original border comprise straight lines only. However, it is not mandatory, and original borders of other two-dimensional objects can comprise either curving lines, or combination of straight and curving lines (see, for example, FIG. 2). In some implementations, respective original borders can fully or partially be formed by lines formed by pluralities of points.

The first original border comprises a first original border portion 2022 being a zigzag line, defined by its coordinates, starting from a first point 2024 determining a beginning of the first original border portion 2022, and ending by a third point 2026 determining an end of the first original border portion 2022.

The second original border comprises a second original border portion 2042 being a zigzag line, defined by its coordinates, starting from a second point 2044 determining a beginning of the second original border portion 2042, and ending by a fourth point 2046 determining an end of the second original border portion 2042. The first original border portion 2022 and the second original border portion 2042 are located in close proximity within a predetermined maximal distance. It means that if the predetermined maximal distance is, for example, 1 millimeter, the first point 2024 is disposed 1 millimeter away from the second point 2044, the third point 2026 is disposed 1 millimeter away from the fourth point 2046, and all other points located on the first original border portion 2022 are located not further that 1 millimeter from the closest point located on the second original border portion 2042.

The first original border portion 2022, being the zigzag line, comprises sections consecutively connecting plurality of vertexes 2024, 2028, 2030, 2032, 2034, 2026 of the first original border portion 2022. Vertexes 2024, 2028, 2030, 2032, 2034, 2026 of the first original border portion 2022 are points where the first original border portion 2022 changes its direction.

The second original border portion 2042, being the zigzag line, comprises sections consecutively connecting plurality of vertexes 2044, 2048, 2050, 2052, 2054, 2046 of the second original border portion 2042. Vertexes 2044, 2048, 2050, 2052, 2054, 2046 of the second original border portion 2042 are points where the second original border portion 2042 changes its direction.

It should be understood that not only zigzag lines can comprise vertexes. Any lines, except straight lines, can comprise vertexes. For example, as it was mentioned above, the first original border portion 2022 of FIG. 2 and the second original border portion 2042 of FIG. 2 have vertexes which are located in local extreme points of curvatures (not numbered).

FIG. 4 illustrates yet another alternative non-limiting implementation of a first graphical object 202 and a second graphical object 204 which coordinates are stored on the information storage medium 104. The first graphical object 202 and the second graphical object 204 are depicted as they could be potentially shown on the display screen 118. In this non-limiting implementation, the first graphical object 202 and the second graphical object 204 are two two-dimensional graphical objects. The first graphical object 202 and the second graphical object 204, in this implementation, is similar to the first graphical object 202 and the second graphical object 204 of FIG. 2, with following exception. The first graphical object 202 of FIG. 4 comprises a first point 402 being located on the first original border portion 2022, and the second graphical object 204 of FIG. 4 comprises a second point 404 being located on the second original border portion 2042. In this implementation, the third point and the fourth point may be not defined by the processor 108 on the first graphical object 202 and the second graphical object 204. The first point 402 and the second point 404 can be selected such that a distance between the first point 402 and the second point 404 is a shortest distance between the first original border portion 2022 and the second original border portion 2042. In other words, in this implementation, the first point 402 and the second point 404 are the closest points within the original curves of the first graphical object 202 and the second graphical object 204.

FIG. 5 illustrates yet another alternative non-limiting implementation of a first graphical object 202 and a second graphical object 204 which coordinates are stored on the information storage medium 104. The first graphical object 202 and the second graphical object 204 are depicted as they could be potentially shown on the display screen 118. In this non-limiting implementation, the first graphical object 202 and the second graphical object 204 are two three-dimensional graphical objects.

The first graphical object 202 and the second graphical object 204 have respectively a first original border (not numbered) and a second original border (not numbered). The first original border and the second original border are represented by surfaces of regular geometric shape, and are defined by their respective coordinates which define positions of surfaces, including points and lines (edges), by references being numbers which determine the position of surfaces, points and lines (edges), in the three-dimensional space with respect to a system of axes (not depicted). The first original border and the second original border comprise plain surfaces (for example, 502 and 504), curving surfaces (for example, 506) plain and curving lines (edges), and points. However, it is not mandatory, and borders of other three-dimensional objects can comprise other elements, such as curving surfaces, as it is depicted in FIG. 6. In some implementations, borders can be fully or partially formed by pluralities of dots and/or lines.

The first original border comprises a first original border portion 2022 being a curving edge, defined by its coordinates, starting from a first point 2024 determining a beginning of the first original border portion 2022, and ending by a third point 2026 determining an end of the first original border portion 2022.

The second original border comprises a second original border portion 2042 being a curving edge, defined by its coordinates, starting from a second point 2044 determining a beginning of the second original border portion 2042, and ending by a fourth point 2046 determining an end of the second original border portion 2042.

The first original border portion 2022 and second original border portion 2042, being the curving edges, can comprise plurality of vertexes being local extreme points of curvatures. Plurality of vertexes of the first original border portion 2022 and second original border portion 2042 are not numbered in FIG. 5 for purpose of ease of understanding FIG. 5.

The first original border portion 2022 and the second original border portion 2042 are located in close proximity within a predetermined maximal distance. It means that if the predetermined maximal distance is, for example, 1 millimeter, the first point 2024 is disposed 1 millimeter away from the second point 2044, the third point 2026 is disposed 1 millimeter away from the fourth point 2046, and all other points located on the first original border portion 2022 are located not further that 1 millimeter from the closest point located on the second original border portion 2042. It should be understood that the predetermined maximal distance can be expressed in any suitable values, such as expressed in metrical system, in system of imperial units, in pixels, etc.

FIG. 6 illustrates yet another alternative non-limiting implementation of a first graphical object 202 and a second graphical object 204 which coordinates are stored on the information storage medium 104. The first graphical object 202 and the second graphical object 204 are depicted as they could be potentially shown on the display screen 118. In this non-limiting implementation, the first graphical object 202 and the second graphical object 204 are two three-dimensional graphical objects.

The first graphical object 202 and the second graphical object 204 have respectively a first original border (not numbered) and a second original border (not numbered). The first original border and the second original border are represented by curving surfaces of irregular geometric shape, and are defined by their respective coordinates which define positions of surfaces by references being numbers which determine the position of surfaces (or points or lines forming surfaces) in the three-dimensional space with respect to a system of axes (not depicted). The first original border and the second original border comprise curving surfaces only. However, it is not mandatory, and borders of other three-dimensional objects can comprise other elements, such as plain surfaces, edges, and others.

The first original border comprises a first original border portion 2022 being a curving surface, defined by its coordinates, starting from a first imaginary loop 602 determining a beginning of the first original border portion 2022, the first original border portion 2022 including the space inside of the loop 602, including a first point 402, the first point 402 being the closest point to the second graphical object 204.

The second original border comprises a second original border portion 2042 being a curving surface, defined by its coordinates, starting from a second imaginary loop 604 determining a beginning of the second original border portion 2042, the second original border portion 2042 including the space inside of the loop 604, including a second point 404, the second point 404 being the closest point to the first graphical object 202.

The first original border portion 2022 and second original border portion 2042, being the curving surfaces, can comprise plurality of vertexes being local extreme points of curvatures. Plurality of vertexes of the first original border portion 2022 and second original border portion 2042 are not numbered in FIG. 6 for purpose of ease of perception of FIG. 6.

The first original border portion 2022 and the second original border portion 2042 are located in close proximity within a predetermined maximal distance. It means that if the predetermined maximal distance is, for example, 1 millimeter, the first imaginary loop 602 is disposed 1 millimeter away from the second imaginary loop 604, both the first imaginary loop 602 and the second imaginary loop 604 being located in parallel imaginary planes (not depicted). All points located within the first original border portion 2022 are located, respectively, within 1 mm distance from at least one respective point located within the second original border portion 2042.

Computer-readable instructions, stored on the information storage medium 104, when executed, can cause the processor 108 to receive instruction to generate a simplified first border and/or a simplified second border. The instruction to generate a simplified first border and/or a simplified second border can be instructions of a user 121 received by the server 102 from the client device 112, which client device 112 will be described in more details below. Alternatively, the instruction to generate a simplified first border and/or a simplified second border can be instructions of the client device 112 itself, received by the server 102 from the client device 112. For example, responsive to user 121 requests zooming out a map, the client device 112 can send to the server 102 corresponding request along with the request to simplify borders of the first graphical object 202 and of the second graphical object 204 to display them in new zoom, without small details, taking into account resolution of the display screen 118 of the client device 112. Alternatively, the client device 112 can send to the server 102 the request to zoom out a map only, and the server 102 can interpret such request as the request to zoom out the map and also as the request to simplify the borders of the first graphical object 202 and of the second graphical object 204.

Computer-readable instructions, stored on the information storage medium 104, when executed, can further cause the processor 108 to detect, by comparing coordinates of the first graphical object 202 and the second graphical object 204, that the first original border portion 2022 and the second original border portion 2042 are located in close proximity within a predetermined maximal distance. For example, computer-readable instructions can cause the processor 108 to detect portions of the first original border and of the second original border which are located within a predetermined maximal distance, for example, within 1 millimeter. These border portions will start and end in points where distance between corresponding start points 2024 and 2044, and between corresponding end points 2026 and 2046, is equal to the predetermined maximal distance 1 mm, provided that the lines go then away one from another.

Computer-readable instructions, stored on the information storage medium 104, when executed, can further cause the processor 108 to select a first point 402 (for example, as depicted in FIG. 4) and a second point 404 (for example, as depicted in FIG. 4) or, alternatively, to select a first point 2024 (for example, as depicted in FIG. 3) and a second point 2044 (for example, as depicted in FIG. 3).

The selection can be performed such that the first point 402 (or 2024) is located on the first original border portion 2022 and the second point 404 (or 2044) is located on the second original border portion 2042.

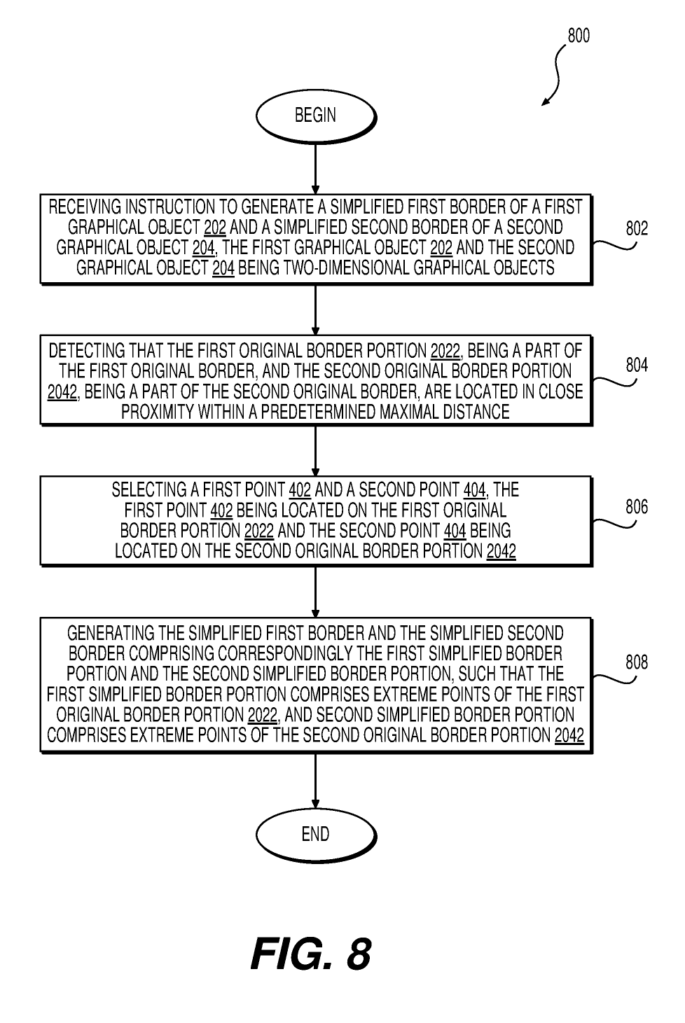

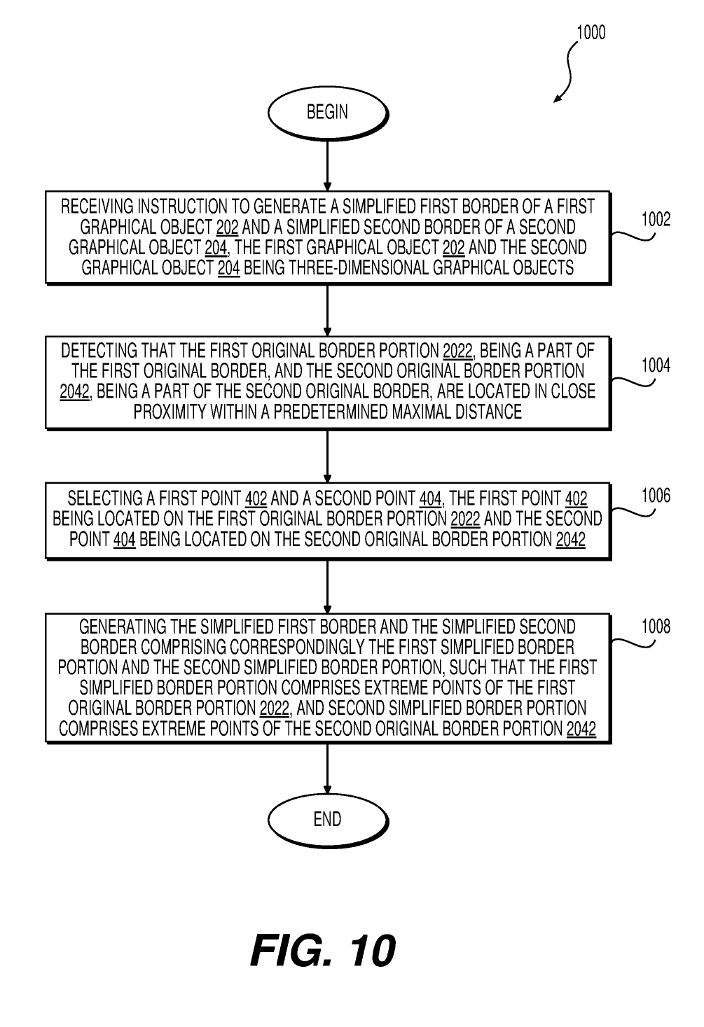

Selecting the first point 402 and the second point 404 can be performed such that a distance between the first point 402 and the second point 404 is a shortest distance between all the points of the first original border portion 2022 and the second original border portion 2042. There can be several points on the first original border portion 2022 and several points on the second original border portion 2042 between which the distance is the shortest distance between the first original border portion 2022 and the second original border portion 2042. For example, this can be if certain parts of the first original border portion 2022 and the second original border portion 2042 are parallel, or not parallel but still equidistant. If many possible options are available, the server 102 may select any suitable pair of points as the first point 402 and the second point 404. The method of selecting point as it is described in this paragraph, is depicted in FIG. 8 and in FIG. 10, and will be described below in more details.

Selecting the first point 2024 and the second point 2044 can be performed such that the first point 2024 is an extreme point of the first original border portion 2022 defining the beginning of the first original border portion 2022, and the second point 2044 is an extreme point of the second original border portion 2042 defining the beginning of the second original border portion 2042, and the first point 2024 and the second point 2044 are located one in front of another. Computer-readable instructions, stored on the information storage medium 104, when executed, can further cause the processor 108 to select a third point 2026 and a fourth point 2046, the third point 2026 being located on the first original border portion 2022 and defining the end of the first original border portion 2022; and the fourth point 2046 being located on the second original border portion 2042 and defining the end of the second original border portion 2042, and the third point 2026 and the fourth point 2046 are located one in front of another.

Two extreme points 2024, 2044 determining beginnings of border portions 2022, 2042 and two extreme points 2026, 2046 determining ends of border portions 2022, 2042 can be selected such that if all four extreme points 2024, 2026, 2044, 2046 consisting of two extreme points 2024, 2026 of the first original border portion 2022 defining the beginning and the end of the first original border portion 2022 and two extreme points 2044, 2046 of the second original border portion 2042 defining the beginning and the end of the second original border portion 2042, are connected by imaginary straight edges 702, 704, 706, 708, 710, 712, an imaginary straight edge 702 connecting the first point 2024 and the second point 2044 is not crossed by any other one of said imaginary straight edges 704, 706, 708, 710, 712, as it is depicted in FIG. 7.

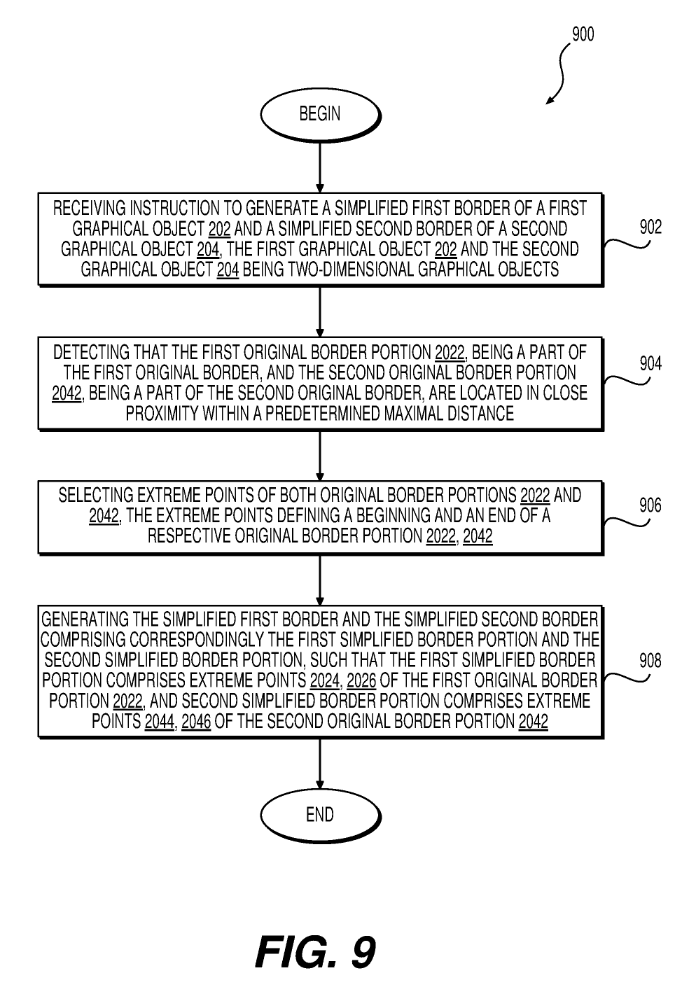

In other words, two points 2024 and 2046 cannot be a pair of the first point and the second point, because an edge 712 connecting points 2024 and 2046 is crossed by an edge 710. Likewise, pair of points 2044 and 2026 cannot be a pair of the first point and the second point, because an edge 710 connecting points 2044 and 2026 is crossed by an edge 712. Points 2024 and 2026 cannot be a pair of the first point and the second point, because the first point and the second point, by definition, have to be located on different border portions, and both points 2024 and 2026 are located on the same the first original border portion 2022. Likewise, points 2044 and 2046 cannot be a pair of the first point and the second point, because the first point and the second point, by definition, have to be located on different border portions, and both points 2044 and 2046 are located on the same the second original border portion 2042. The method of selecting point as it is described in this paragraph and in the preceding paragraph, is depicted in FIG. 9 and will be described below in more details.

As depicted in FIG. 7, points 2026 and 2046 are located on different border portions—on the the first original border portion 2022 and on the second original border portion 2042, and points 2026 and 2046 are connected by the edge 704 which is not crossed by other edges 702, 706, 708, 710, 712. Therefore points 2026 and 2046 potentially can be beginning points. In such a case, points 2024 and 2044 would be end points.

In other words, beginning points must be facing each other, and end points must be facing each other, too. Two end points can be considered to be beginning points and the beginning points can be considered end points. Thus, words “beginning” and “end” are only used in this context to distinguish corresponding pairs of opposed points defining extremes of the first original border portion 2022 and the second original border portion 2042.

Computer-readable instructions, stored on the information storage medium 104, when executed, can further cause the processor 108 to generate the simplified first border and the simplified second border comprising correspondingly the first simplified border portion and the second simplified border portion, by applying a single simplification rule both to the first original border portion 2022 and to the second original border portion 2042, such that: the first point 402 (or, in some implementations, 2024) is located on the first simplified border portion, and the second point 404 (or, in some implementations, 2044) is located on the second simplified border portion. In other words, the first point 402 (2024) and the second point 404 (2044) are fixed, and respective simplified borders comprise these first point 402 (2024) and second point 404 (2044), as original borders did.

In some implementations, generating the simplified first border and the simplified second border comprises simplifying the first original border and the second original border such that the first simplified border portion and the second simplified border portion further comprise, correspondingly, the third point 2026 and the fourth point 2046. In other words, the third point 2026 and the fourth point 2046 are fixed, and respective simplified borders comprise these third point 2026 and fourth point 2046, as original borders did. As a result, simplification would not affect respective positions of these points, and their respective position will be the same as before applying the single simplification rule.

In some implementations, the single simplification rule can comprise reducing number of vertexes of the first original border portion 2022 and reducing number of vertexes of the second original border portion 2042. As a non-limiting example, referring to numeration of vertexes in FIG. 3, each second vertex within both the first original border portion 2022 and the second original border portion 2042, if counting starting from 2024 and 2044, can be eliminated, except points determining beginning and the end of a respective border portion. Thus, vertexes 2028 and 2048, 2032 and 2052 can be eliminated. As a result, in this implementation, the first simplified border will be a line connecting vertexes 2024-2030-2034-2026, and the second simplified border will be a line connecting vertexes 2044-2050-2054-2046.

Computer-readable instructions, stored on the information storage medium 104, when executed, can further cause the processor 108 to send to a client device 112 an instruction to display the at least part of the simplified first border and the at least part of the simplified second border on the display screen 118. The instruction can be sent via communication network 110. In some implementations, the instruction to display the at least part of the simplified first border and the at least part of the simplified second border on a display screen 118 can comprise an instruction to zoom a visual presentation of the at least part of the simplified first border and the at least part of the simplified second border, such that the at least part of the simplified first border and the at least part of the simplified second border looks larger or smaller.

The system 100 further comprises a client device 112. The client device 112 is typically associated with a user 121. The client device 112 is a kind of a computing device. It should be noted that the fact that the client device 112 is associated with the user does not need to suggest or imply any mode of operation—such as a need to log in, a need to be registered or the like.

The implementation of the client device 112 is not particularly limited, but as an example, the client device 112 may be implemented as a personal computer (desktops, laptops, netbooks, etc.) or as a wireless communication device (a smartphone, a tablet and the like).

The client device 112 comprises a user input device (not depicted). How the user input device is implemented is not particularly limited and may depend on how the client device 112 is implemented. The user input device may include any mechanism for providing user input to the processor 116. The user input device can be a keyboard, and/or a mouse, and so on. The input device is not limited to any specific input methodology, but could be arranged by a virtual button on a touch-screen display or a physical button on the cover of the electronic device, for instance.

Merely as an example and not as a limitation, in those embodiments of the present technology where the client device 112 is implemented as a wireless communication device (such as a smartphone), user input device can be implemented as an optical interference based user input device. The user input device of one example is a finger/object movement sensing device on which a user performs a gesture and/or presses with a finger. The user input device 113 can identify/track the gesture and/or determines a location of a user's finger on the user input device 113. In the instances where the user input device is executed as the optical interference based user input device, such as touch screen, or multi-touch display, the user input device can further execute functions of the display screen 118.

The user input device is communicatively coupled to a processor 116 and transmits input signals (and output signals where it also operates as the display screen 118) based on various forms of user input for processing and analysis by processor 116.

The client device 112 further comprises an information storage medium 114, also referred to as the local memory 114. Local memory 114 can comprise any type of media, including but not limited to RAM, ROM, disks (CD-ROMs, DVDs, floppy disks, hard drivers, etc.), USB keys, solid state-drives, tape drives, etc. Generally speaking, the purpose of the local memory 114 is to store computer readable instructions as well as any other data.

The client device 112 further comprises the display screen 118. Display screen 118 can be liquid crystal display (LCD), light emitting diode (LED), Interferometric modulator display (IMOD), or any other suitable display technology. The display screen 118 is generally configured to display a graphical user interface (GUI) that provides an easy to use visual interface between the user 121 of the client device 112 and the operating system or application(s) running on the client device 112. Generally, the GUI presents programs, files and operational options with graphical images. Display screen 118 is also generally configured to display other information like user data and web resources. Display screen 118 can also be touch based devices such as touch screen. A touch screen is a display that detects the presence and location of user touch inputs. Display screen 118 can also be dual touch or multi-touch displays that can identify the presence, location and movement of a touch inputs. In the instances where the display screen 118 is implemented as a touch based device such as touch screen, or multi-touch display, the display screen 118 can execute functions of the user input device.

The display screen 118 is communicatively coupled to processor 116 and receives signals from the processor 116. In instances where display screen 118 is implemented as a touch based device such as touch screen, or multi-touch display, the display screen 118 can also transmit input signals based on various forms of user input for processing and analysis by processor 116.

The client device 112 further comprises the above mentioned processor 116. The processor 116 is configured to perform various operations in accordance with a machine-readable program code. The processor 116 is operatively coupled to the user input device, to the local memory 114, and to the display screen 118. The processor 116 is configured to have access to computer readable instructions which instructions, when executed, cause the processor to execute the various routines. As non-limiting examples, the processor 116 described herein can have access to computer readable instructions, which instructions, when executed, can cause the processor to: display information on the display screen 118; receive from a user 121 of the client device 112 via the user input device a selection of at least some of the displayed information; send, by the client device 112 to a server 102 via a communication network 110, the user-selected information; receive by the client device 112 from the server 102 web content and other data, including maps, representation of graphical objects (including video), and other data for displaying on the display screen 118 of the client device 112; display on the display screen 118 a graphical objects, including graphical objects being represented by simplified borders.

The local memory 114 is configured to store data, including computer-readable instructions and other data, including graphical objects data of any kind. In some implementations of the present technology, the local memory 114 can store at least part of the data in a database (not depicted). In other implementations of the present technology, the local memory 114 can store at least part of the data in any collections of data other than databases.

Data stored on the local memory 114 (and more particularly, at least in part, in some implementations, in the database) can comprise graphical objects of any kind. Non-limiting examples of graphical objects are depicted in FIG. 2, FIG. 3, FIG. 4, FIG. 5, FIG. 6, and FIG. 7. The graphical objects depicted in FIG. 2, FIG. 3, FIG. 4, FIG. 5, FIG. 6, and FIG. 7 are described in more details above.

The local memory 114 can store computer-readable instructions that manage control, updates, populating and modifications of the database and/or other collections of data. More specifically, computer-readable instructions stored on the local memory 114 allow the client device 112 to receive (to update) information in respect of graphical objects (for example, from input device, or via the communication network 110, and so on), to store information in respect of the graphical objects, including the information in respect of their respective perimeters in the database, and/or in other collections of data.

Computer-readable instructions, stored on the local memory 114, when executed, can cause the processor 116 to receive instruction to generate a simplified first border and/or a simplified second border. The instruction to generate a simplified first border and/or a simplified second border can be instructions of a user 121 received by the client device 112 via the input device.

In some implementations of the present technology, instruction to generate a simplified first border and/or a simplified second border can be executed on the server 102, so that client device 112 transmits the instructions to the server 102. Further, computer-readable instructions, stored on the local memory 114, when executed, can cause the processor 116 to receive, from the server 102, as a result of processing by the server 102, an instruction to display the at least part of the simplified first border and the at least part of the simplified second border on a display screen 118. The instruction to display the at least part of the simplified first border and the at least part of the simplified second border on a display screen 118 can be received from the server 102 via communication network 110. In some implementations, the instruction to display the at least part of the simplified first border and the at least part of the simplified second border on a display screen 118 of the client device 112 can comprise an instruction to zoom a visual presentation of the at least part of the simplified first border and the at least part of the simplified second border.

In alternative implementations of the present technology, an instruction to generate a simplified first border and/or a simplified second border can be executed locally, on the client device 112, without contacting the server 102.

More particularly, computer-readable instructions, stored on the local memory 114, when executed, can cause the processor 116 to detect, by comparing coordinates of the first graphical object 202 and the second graphical object 204, that the first original border portion 2022 and the second original border portion 2042 are located in close proximity within a predetermined maximal distance. For example, computer-readable instructions can cause the processor 116 to detect portions of the first original border and of the second original border which are located within a predetermined maximal distance, for example, within 1 millimeter. These border portions will start and end in points where distance between corresponding start points 2024 and 2044, and between corresponding end points 2026 and 2046, is equal to the predetermined maximal distance 1 mm, provided that the lines go then away one from another.

Computer-readable instructions, stored on the local memory 114, when executed, can further cause the processor 116 to select a first point 402 (for example, as depicted in FIG. 4) and a second point 404 (for example, as depicted in FIG. 4) or, alternatively, to select a first point 2024 (for example, as depicted in FIG. 3) and a second point 2044 (for example, as depicted in FIG.

3).

The selection can be performed such that the first point 402 (or 2024) would be located on the first original border portion 2022 and the second point 404 (or 2044) would be located on the second original border portion 2042.

Selecting the first point 402 and the second point 404 can be performed such that a distance between the first point 402 and the second point 404 is a shortest distance between the first original border portion 2022 and the second original border portion 2042. There can be several points on the first original border portion 2022 and several points on the second original border portion 2042 between which the distance is the shortest distance between the first original border portion 2022 and the second original border portion 2042. For example, this can be if certain parts of the first original border portion 2022 and the second original border portion 2042 are parallel, or not parallel but still equidistant.

Selecting the first point 2024 and the second point 2044 can be performed such that the first point 2024 is an extreme point of the first original border portion 2022 defining the beginning of the first original border portion 2022, and the second point 2044 is an extreme point of the second original border portion 2042 defining the beginning of the second original border portion 2042, and the first point 2024 and the second point 2044 are located one in front of another. Computer-readable instructions, stored on the local memory 114, when executed, can further cause the processor 116 to select a third point 2026 and a fourth point 2046, the third point 2026 being located on the first original border portion 2022 and defining the end of the first original border portion 2022; and the four point 2046 being located on the second original border portion 2042 and defining the end of the second original border portion 2042, and the third point 2026 and the fourth point 2046 are located one in front of another.

Two extreme points 2024, 2044 determining beginnings of border portions 2022, 2042 and two extreme points 2026, 2044 determining ends of border portions 2022, 2042 can be selected such that if all four extreme points 2024, 2026, 2044, 2046 consisting of two extreme points 2024, 2026 of the first original border portion 2022 defining the beginning and the end of the first original border portion 2022 and two extreme points 2044, 2046 of the second original border portion 2042 defining the beginning and the end of the second original border portion 2042, are connected by imaginary straight edges 702, 704, 706, 708, 710, 712, an imaginary straight edge 702 connecting the first point 2024 and the second point 2044 is not crossed by any other one of said imaginary straight edges 704, 706, 708, 710, 712, as it is depicted in FIG. 7.

In other words, pair of points 2024 and 2046 cannot be a pair of the first point and the second point, because an edge 712 connecting points 2024 and 2046 is crossed by an edge 710. Likewise, pair of points 2044 and 2026 cannot be a pair of the first point and the second point, because an edge 710 connecting points 2044 and 2026 is crossed by an edge 712. Points 2024 and 2026 cannot be a pair of the first point and the second point, because the first point and the second point, by definition, have to be located on different border portions, and both points 2024 and 2026 are located on the same the first original border portion 2022. Likewise, points 2044 and 2046 cannot be a pair of the first point and the second point, because the first point and the second point, by definition, have to be located on different border portions, and both points 2044 and 2046 are located on the same the second original border portion 2042.

Computer-readable instructions, stored on the local memory 114, when executed, can further cause the processor 116 to generate the simplified first border and the simplified second border comprising correspondingly the first simplified border portion and the second simplified border portion, by applying a single simplification rule both to the first original border portion 2022 and to the second original border portion 2042, such that: the first point 402 (or, in some implementations, 2024) is located on the first simplified border portion, and the second point 404 (or, in some implementations, 2044) is located on the second simplified border portion. In other words, the first point 402 (2024) and the second point 404 (2044) are fixed, and respective simplified borders comprise these first point 402 (2024) and second point 404 (2044), as original borders did.

In some implementations, generating the simplified first border and the simplified second border comprises simplifying the first original border and the second original border such that the first simplified border portion and the second simplified border portion further comprise, correspondingly, the third point 2026 and the fourth point 2046. In other words, the third point 2026 and the fourth point 2046 are fixed, and respective simplified borders comprise these third point 2026 and fourth point 2046, as original borders did.

In some implementations, the single simplification rule can comprise reducing number of vertexes of the first original border portion 2022 and reducing number of vertexes of the second original border portion 2042.

Computer-readable instructions, stored on the local memory 114, when executed, can further cause the processor 116 to render the at least part of the simplified first border and the at least part of the simplified second border on a display screen 118. In some implementations, rendering the at least part of the simplified first border and the at least part of the simplified second border on the display screen 118 is rendering scaled visual presentation of the at least part of the simplified first border and the at least part of the simplified second border. Rendering the at least part of the simplified first border and the at least part of the simplified second border can be the result of either receiving corresponding instructions from the server 102, or the result of processing original borders by the processor 116, as it is described in more details when describing steps of the method 800 below.

The client device 112 comprises inter alia a network communication interface 119 (such as a modem, a network card and the like) for two-way connection with the communication network 110. The client device 112 is coupled to the communication network 110, using the network communication interface 119, via a communication link (not numbered). In some non-limiting embodiments of the present technology, the communication network 110 can be implemented as the Internet. In other embodiments of the present technology, the communication network 110 can be implemented differently, such as any wide-area communications network, local-area communications network, a private communications network and the like. The client device 112 can establish connections, through the communication network 110, with other devices, such as servers. More particularly, the client device 112 can establish connections and interact with the server 102.

How the communication link is implemented is not particularly limited and will depend on how the client device 112 is implemented. Merely as an example and not as a limitation, in those embodiments of the present technology where the client device 112 is implemented as a wireless communication device (such as a smartphone), the communication link can be implemented as a wireless communication link (such as but not limited to, a 3G communications network link, a 4G communications network link, a Wireless Fidelity, or WiFi® for short, Bluetooth® and the like). In those examples, where the client device 112 is implemented as a notebook computer, the communication link can be either wireless (such as the Wireless Fidelity, or WiFi® for short, Bluetooth® or the like) or wired (such as an Ethernet based connection).

It should be expressly understood that implementations for the client device 112, the communication link and the communication network 110 are provided for illustration purposes only. As such, those skilled in the art will easily appreciate other specific implementation details for the client device 112, the communication link and the communication network 110. As such, by no means, examples provided herein above are meant to limit the scope of the present technology.

FIG. 8 illustrates a computer-implemented method 800 for generating a simplified first border of a first graphical object 202 and a simplified second border of a second graphical object 204, depicted in FIG. 4, both the first graphical object 202 and the second graphical object 204 having respectively a first original border and a second original border, the first original border and the second original border being defined by their respective coordinates, the first original border comprising a first original border portion 2022, the second original border comprising a second original border portion 2042. The first graphical object 202 and the second graphical object 204, in this implementation, are two dimensional objects which can be used in graphical design, both graphical objects being stored on the information storage medium 104 of the server 102.

In this implementation of the present technology, the steps of the method 800 are executed on the server 102 of the system 100 of FIG. 1. In other implementations of the present technology, steps of the method 800 can be executed on the client device 112 of the system 100 of FIG. 1.

### Step 802—Receiving Instruction to Generate a Simplified First Border of a First Graphical Object 202 and a Simplified Second Border of a Second Graphical Object 204

The method 800 starts at step 802, where the server 102 receives from the client device 112 instruction to generate a simplified first border of a first graphical object 202 and a simplified second border of a second graphical object 204.

In this implementation, in addition to receiving from the client device 112 instruction to generate the simplified first border of the first graphical object 202 and the simplified second border of the second graphical object 204, the server 102 also receives from the client device 112 the user 121 request for displaying the first graphical object 202 and the second graphical object 204 in fewer details. However, in other implementations, the server 102 may receive instructions to simplify the first border of the first graphical object 202 and the second border of the second graphical object 204 without changing a picture scale.

Then, the method 800 proceeds to the step 804.

Step 804—Detecting, by Comparing Coordinates of the First Graphical Object 202 and the Second Graphical Object 204, that the First Original Border Portion 2022 and the Second Original Border Portion 2042 are Located in Close Proximity within a Predetermined Maximal Distance

Next, at step 804, the processor 108 executes computer-readable instructions, stored on the information storage medium 104, which instructions cause the processor to compare coordinates of the first graphical object 202 and the second graphical object 204, and to detect that the first original border portion 2022 and the second original border portion 2042 are located in close proximity within a predetermined maximal distance. For example, computer-readable instructions can cause the processor 108 to detect portions of the first original border and of the second original border which are located within a predetermined maximal distance, for example, within ½ inch. These border portions will start and end in points where distance between corresponding start points 2024 and 2044, and between corresponding end points 2026 and 2046, is equal to the predetermined maximal distance ½ inch, provided that the lines diverge from another (one should appreciate that if the lines diverge from each other, the distance between them would exceed the predetermined maximal distance ½ inch).

Then, the method 800 proceeds to the step 806.

### Step 806—Selecting a First Point 402 and a Second Point 404, the First Point 402 Being Located on the First Original Border Portion 2022 and the Second Point 404 Being Located on the Second Original Border Portion 2042

Next, at step 806, the processor 108 executes computer-readable instructions, stored on the information storage medium 104, which instructions cause the processor to select the first point 402 and the second point 404, the first point 402 being located on the first original border portion 2022 and the second point 404 being located on the second original border portion 2042.

Selecting the first point 402 and the second point 404 can be performed such that a distance between the first point 402 and the second point 404 is a shortest distance between the first original border portion 2022 and the second original border portion 2042. For example, if the shortest distance between the first original border portion 2022 and the second original border portion 2042 is 1/16 inch, the the first point 402 and the second point 404 will be selected such that the straight line connecting the first point 402 and the second point 404 would be 1/16 inch long. Selecting the first point 402 and the second point 404 can be performed, for example, by comparing coordinates of points located within the first original border portion 2022 with coordinates of points located within the second original border portion 2042.

Then, the method 800 proceeds to the step 808.

Step 808—Generating the Simplified First Border and the Simplified Second Border Comprising Correspondingly the First Simplified Border Portion and the Second Simplified Border Portion, Such that the First Simplified Border Portion Comprises the First Point 402 of the First Original Border Portion 2022, and Second Simplified Border Portion Comprises The Second Point 404 Of The Second Original Border Portion 2042

Next, at step 808, computer-readable instructions, stored on the information storage medium 104, when executed, further cause the processor 108 to generate the simplified first border and the simplified second border comprising correspondingly the first simplified border portion and the second simplified border portion, by applying a single simplification rule both to the first original border portion 2022 and to the second original border portion 2042, such that the first point 402 is located on the first simplified border portion, and the second point 404 is located on the second simplified border portion. In other words, the first point 402 and the second point 404 are fixed at the same position where they located before applying the single simplification rule. As a result, respective simplified borders comprise these two points 402 and 404. Applying the single simplification rule both to the first original border portion 2022 and to the second original border portion 2042 do not affect the position of these points 402, 404.

The method 800 then ends.

FIG. 9 illustrates a computer-implemented method 900 for generating a simplified first border of a first graphical object 202 and a simplified second border of a second graphical object 204, depicted in FIG. 2, both the first graphical object 202 and the second graphical object 204 having respectively a first original border and a second original border, the first original border and the second original border being defined by their respective coordinates, the first original border comprising a first original border portion 2022, the second original border comprising a second original border portion 2042. The first graphical object 202 and the second graphical object 204, in this implementation, are two-dimensional map objects stored in the database 106 on the information storage medium 104 of the server 102.

In this implementation of the present technology, the steps of the method 900 are executed on the server 102 of the system 100 of FIG. 1. In other implementations of the present technology, steps of the method 900 can be executed on the client device 112 of the system 100 of FIG. 1.

### Step 902—Receiving Instruction to Generate a Simplified First Border of a First Graphical Object 202 and a Simplified Second Border of a Second Graphical Object 204

The method 900 starts at step 902, where the server 102 receives from the client device 112 instruction to generate a simplified first border of a first graphical object 202 and a simplified second border of a second graphical object 204.

The server 102 also receives from the client device 112 the user 121 request for displaying the first graphical object 202 and the second graphical object 204 in smaller details.

Then, the method 900 proceeds to the step 904.

Step 904—Detecting, by Comparing Coordinates of the First Graphical Object (202) and the Second Graphical Object (204), that the First Original Border Portion (2022) and the Second Original Border Portion (2042) are Located in Close Proximity Within a Predetermined Maximal Distance

Next, at step 904, the processor 108 executes computer-readable instructions, stored on the information storage medium 104, which instructions cause the processor to compare coordinates of the first graphical object 202 and the second graphical object 204, and to detect that the first original border portion 2022 and the second original border portion 2042 are located in close proximity within a predetermined maximal distance. For example, computer-readable instructions can cause the processor 108 to detect portions of the first original border and of the second original border which are located within a predetermined maximal distance, for example, within 1 millimeter. These border portions will start and end in points where distance between corresponding start points 2024 and 2044, and between corresponding end points 2026 and 2046, is equal to the predetermined maximal distance 1 mm, provided that the lines go then away one from another.

Then, the method 900 proceeds to the step 906.

Step 906—Selecting a First Point 2024 and a Third Point 2026 being Located on the First Original Border Portion 2022 and Defining its Beginning and the End; and Selecting a Second Point 2044 and a Fourth Point 2046 Being Located on the Second Original Border Portion 2042 and Defining its Beginning and the End

Next, at step 906, the processor 108 executes computer-readable instructions, stored on the information storage medium 104, which instructions cause the processor to select a first point 2024 and a third point 2026 being located on the first original border portion 2022 and defining its beginning and the end; and to select a second point 2044 and a fourth point 2046 being located on the second original border portion 2042 and defining its beginning and the end.

Selecting the first point 2024 and the second point 2044 can be performed such that the first point 2024 is an extreme point of the first original border portion 2022 defining the beginning of the first original border portion 2022, and the second point 2044 is an extreme point of the second original border portion 2042 defining the beginning of the second original border portion 2042, and the first point 2024 and the second point 2044 are located one in front of another. Computer-readable instructions, stored on the information storage medium 104, when executed, can further cause the processor 108 to select a third point 2026 and a fourth point 2046, the third point 2026 being located on the first original border portion 2022 and defining the end of the first original border portion 2022; and the four point 2046 being located on the second original border portion 2042 and defining the end of the second original border portion 2042, and the third point 2026 and the fourth point 2046 are located one in front of another.

Two extreme points 2024, 2044 determining beginnings of border portions 2022, 2042 and two extreme points 2026, 2044 determining ends of border portions 2022, 2042 can be selected such that if all four extreme points 2024, 2026, 2044, 2046 consisting of two extreme points 2024, 2026 of the first original border portion 2022 defining the beginning and the end of the first original border portion 2022 and two extreme points 2044, 2046 of the second original border portion 2042 defining the beginning and the end of the second original border portion 2042, are connected by imaginary straight edges 702, 704, 706, 708, 710, 712, an imaginary straight edge 702 connecting the first point 2024 and the second point 2044 is not crossed by any other one of said imaginary straight edges 704, 706, 708, 710, 712, as it is depicted in FIG. 7.

In other words, pair of points 2024 and 2046 cannot be a pair of the first point and the second point, because an edge 712 connecting points 2024 and 2046 is crossed by an edge 710. Likewise, pair of points 2044 and 2026 cannot be a pair of the first point and the second point, because an edge 710 connecting points 2044 and 2026 is crossed by an edge 712. Points 2024 and 2026 cannot be a pair of the first point and the second point, because the first point and the second point, by definition, have to be located on different border portions, and both points 2024 and 2026 are located on the same the first original border portion 2022. Likewise, points 2044 and 2046 cannot be a pair of the first point and the second point, because the first point and the second point, by definition, have to be located on different border portions, and both points 2044 and 2046 are located on the same the second original border portion 2042.

Then, the method 900 proceeds to the step 908.

Step 908—Generating the Simplified First Border and the Simplified Second Border Comprising Correspondingly the First Simplified Border Portion and the Second Simplified Border Portion, Such that the First Simplified Border Portion Comprises Extreme Points of the First Original Border Portion 2022, and Second Simplified Border Portion Comprises Extreme Points of the Second Original Border Portion 2042

Next, at step 908, computer-readable instructions, stored on the information storage medium 104, when executed, further cause the processor 108 to generate the simplified first border and the simplified second border comprising correspondingly the first simplified border portion and the second simplified border portion, by applying a single simplification rule both to the first original border portion 2022 and to the second original border portion 2042, such that: the first point 2024 and the third point 2026 are located on the first simplified border portion, and the second point 2044 and the fourth point 2046 are located on the second simplified border portion. In other words, the first point 2024, the third point 2026, the second point 2044, and the fourth point 2046 are fixed, and respective simplified borders comprise these four points 2024, 2026, 2044, 2046, as original borders did. Therefore, applying the single simplification rule both to the first original border portion 2022 and to the second original border portion 2042 do not affect the position of these points.

In this implementation, the single simplification rule comprises reducing number of vertexes of the first original border portion 2022 and reducing number of vertexes of the second original border portion 2042. As a non-limiting example, referring to numeration of vertexes in FIG. 3, each second vertex within both the first original border portion 2022 and the second original border portion 2042, if counting starting from 2024 and 2044, can be eliminated, except points determining beginning and the end of a respective border portion. Thus, vertexes 2028 and 2048, 2032 and 2052 can be eliminated. As a result, in this implementation, the first simplified border will be a line connecting vertexes 2024-2030-2034-2026, and the second simplified border will be a line connecting vertexes 2044-2050-2054-2046.

The method 900 then ends.

Both the method 800 and the method 900 illustrate the methods for generating simplified borders of two-dimensional graphical objects. However, persons skilled in the art will appreciate that simplified borders of three-dimensional graphical objects can be generated by performing steps similar to steps of method 800 and of method 900. For better clarity, FIG. 10 depicts a computer-implemented method 1000, similar to method 800, for generating a simplified first border of a first graphical object 202 and a simplified second border of a second graphical object 204, depicted in FIG. 6, both the first graphical object 202 and the second graphical object 204 having respectively a first original border and a second original border, the first original border and the second original border being defined by their respective coordinates, the first original border comprising a first original border portion 2022, the second original border comprising a second original border portion 2042. The first graphical object 202 and the second graphical object 204, in this implementation, are three-dimensional graphical objects stored in the database 106 on the information storage medium 104 of the server 102.

In this implementation of the present technology, the steps of the method 1000 are executed on the client device 112 of the system 100 of FIG. 1. In other implementations of the present technology, steps of the method 1000 can be executed on the server 102 of the system 100 of FIG. 1.

### Step 1002—Receiving Instruction to Generate a Simplified First Border of a First Graphical Object 202 and a Simplified Second Border of a Second Graphical Object 204

The method 1000 starts at step 1002, where the client device 112 receives from the user 121 instruction to generate a simplified first border of a first graphical object 202 and a simplified second border of a second graphical object 204.

More particularly, the processor 116 of the client device 112 receives, via the input device, instruction to generate a simplified first border and a simplified second border.

Then, the method 1000 proceeds to the step 1004.

Step 1004—Detecting, by Comparing Coordinates of the First Graphical Object 202 and the Second Graphical Object 204, that the First Original Border Portion 2022 and the Second Original Border Portion 2042 are Located in Close Proximity Within a Predetermined Maximal Distance

Next, at step 1004, the processor 116 executes computer-readable instructions, stored on the local memory 114, which instructions cause the processor to compare coordinates of the first graphical object 202 and the second graphical object 204, and to detect that the first original border portion 2022 and the second original border portion 2042 are located in close proximity within a predetermined maximal distance. For example, computer-readable instructions can cause the processor 116 to detect portions of the first original border and of the second original border which are located within a predetermined maximal distance, for example, within 90 pixels. The first original border portion 2022 and the second original border portion 2042 are in this implementation curving surfaces, defined by their respective coordinates.

The processor 116 can detect that the first original border portion 2022 is a space located within a first imaginary loop 602, and that the second original border portion 2042 is a space located within a second imaginary loop 604. The first imaginary loop 602 and the second imaginary loop 604 are imaginary lines which are located on two imaginary parallel planes (not depicted in FIG. 6) on the distance of 90 pixels one from another. Therefore, in this implementation, any point on the surface of both three dimensional objects 202 and 204 are located within distance of 90 pixels.

Then, the method 1000 proceeds to the step 1006.

Step 1006—Selecting a First Point 402 and a Second Point 404, the First Point 402 Being Located on the First Original Border Portion 2022 and the Second Point 404 being Located on the Second Original Border Portion 2042

Next, at step 1006, the processor 116 executes computer-readable instructions, stored on the local memory 114, which instructions cause the processor 116 to select the first point 402 and the second point 404, the first point 402 being located on the first original border portion 2022 and the second point 404 being located on the second original border portion 2042.

Selecting the first point 402 and the second point 404 can be performed such that the first point a distance between the first point 402 and the second point 404 is a shortest distance between the first original border portion 2022 and the second original border portion 2042. For example, if the shortest distance between the first original border portion 2022 and the second original border portion 2042 is 34 pixels, the the first point 402 and the second point 404 will be selected such that the straight line connecting the first point 402 and the second point 404 would be equal to 34 pixels. Selecting the first point 402 and the second point 404 can be performed, for example, by comparing coordinates of points located within the first original border portion 2022 with coordinates of points located within the second original border portion 2042.

Then, the method 1000 proceeds to the step 1008.

Step 1008—Generating the Simplified First Border and the Simplified Second Border Comprising Correspondingly the First Simplified Border Portion and the Second Simplified Border Portion, such that the First Simplified Border Portion Comprises the First Point 402 of the First Original Border Portion 2022, and Second Simplified Border Portion Comprises the Second Point 404 of the Second Original Border Portion 2042

Next, at step 1008, computer-readable instructions, stored on the local memory 114, when executed, further cause the processor 116 to generate the simplified first border and the simplified second border comprising correspondingly the first simplified border portion and the second simplified border portion, by applying a single simplification rule both to the first original border portion 2022 and to the second original border portion 2042, such that the first point 402 is located on the first simplified border portion, and the second point 404 is located on the second simplified border portion. In other words, the first point 402 and the second point 404 are fixed on the same position where they located before applying the single simplification rule. As a result, respective simplified borders comprise these two points 402 and 404. Applying the single simplification rule both to the first original border portion 2022 and to the second original border portion 2042 do not affect the position of these points 402, 404.

The method 1000 then ends.

Performing steps of the methods 800, 900, and 1000 allows simplifying borders of graphical objects by fixing certain points on border lines or on border surfaces such that distance between and interposition among which would be kept intact. In some implementations, such fixing of points in combination with applying the single simplification rule may allow keeping closely located borders of graphical objects so that they do not touch each other after simplification (which can be undesirable, as a non-limiting example, when a map service display a river on the map, or where a sword in a computer game does not touch an enemy, and the like). Performing steps of the methods 800, 900, and 1000 allows simplifying borders of graphical objects by preserving distances between graphical objects in those cases where not preserving distances would cause undesirable change of interpositions of graphical objects. Such undesirable interposition of graphical object would result in the user attempting to refocus (for example, zoom in and zoom out, etc), placing an undesirable strain on computer processing resources.

From a certain perspective, embodiments of the present technology can be summarized as follows, structured in numbered clauses:

Clause 1. A method for generating a simplified first border of a first graphical object (202) and a simplified second border of a second graphical object (204), both the first graphical object (202) and the second graphical object (204) having respectively a first original border and a second original border, the first original border and the second original border being defined by their respective coordinates, the first original border comprising a first original border portion (2022), the second original border comprising a second original border portion (2042), the method executable on a computing device (102, 112), the method comprising:
receiving instruction to generate the simplified first border and the simplified second border;
detecting, by comparing coordinates of the first graphical object (202) and the second graphical object (204), that the first original border portion (2022) and the second original border portion (2042) are located in close proximity within a predetermined maximal distance;
selecting a first point (402, 2024) and a second point (404, 2044), the first point (402, 2024) being located on the first original border portion (2022) and the second point (404, 2044) being located on the second original border portion (2042);
generating the simplified first border and the simplified second border comprising correspondingly a first simplified border portion and a second simplified border portion, by applying a single simplification rule both to the first original border portion (2022) and to the second original border portion (2042), such that:
   the first point (402, 2024) is located on the first simplified border portion, and
   the second point (404, 2044) is located on the second simplified border portion.

Clause 2. The method of clause 1, wherein selecting the first point (402) and the second point (404) is performed such that a distance between the first point (402) and the second point (404) is a shortest distance between the first original border portion (2022) and the second original border portion (2042).

Clause 3. The method of clause 1, wherein the first original border portion (2022) comprises two extreme points defining a beginning and an end of the first original border portion (2022), and the second original border portion (2042) comprises two extreme points defining a beginning and an end of the second original border portion (2042); and wherein selecting the first point (2024) and the second point (2044) is performed such that:
the first point (2024) is an extreme point of the first original border portion (2022) defining the beginning of the first original border portion (2022), and

the second point (2044) is an extreme point of the second original border portion (2042) defining the beginning of the second original border portion (2042), and
the first point (2024) and the second point (2044) are located one in front of another, such that if all four extreme points (2024, 2026, 2044, 2046) consisting of two extreme points (2024, 2026) of the first original border portion (2022) defining the beginning and the end of the first original border portion (2022) and two extreme points (2044, 2046) of the second original border portion (2042) defining the beginning and the end of the second original border portion (2042), are connected by imaginary straight edges (702, 704, 706, 708, 710, 712), an imaginary straight edge (702) connecting the first point (2024) and the second point (2044) is not crossed by any other one of said imaginary straight edges (704, 706, 708, 710, 712).

Clause 4. The method of clause 1, further comprising:
selecting a third point (2026) and a fourth point (2046), the third point (2026) being located on the first original border portion (2022) and the four point (2046) being located on the second original border portion (2042), wherein:
   (i) selecting the first point (2024) and the third point (2026) is performed such that the first point (2024) and the third point (2026) are extreme points of the first original border portion (2022) defining a beginning and the end of the first original border portion (2022), and
   (ii) selecting the second point (2044) and the four point (2046) is executed such that the second point (2044) and the fourth point (2046) are extreme points of the second original border portion (2042) defining a beginning and an end of the second original border portion (2042); and
wherein:
   generating the simplified first border and the simplified second border comprising correspondingly the first simplified border portion and the second simplified border portion, is performed such that:
      the first point (2024) and the third point (2026) are located on the first simplified border portion, and
      the second point (2044) and the fourth point (2046) are located on the second simplified border portion.

Clause 5. The method of any one of clauses 1 to 4, wherein
the first original border portion (2022) comprises sections consecutively connecting plurality of vertexes (2024, 2028, 2030, 2032, 2034, 2026) of the first original border portion (2022),
the second original border portion (2042) comprises sections consecutively connecting plurality of vertexes (2044, 2048, 2050, 2052, 2054, 2046) of the second original border portion (2042); and wherein
the single simplification rule comprises reducing number of vertexes of the first original border portion (2022) and number of vertexes of the second original border portion (2042).

Clause 6. The method of any one of clauses 1 to 5, wherein the computing device is any one, selected from: a server (102), and a client device (112).

Clause 7. The method of any one of clauses 1 to 5, wherein the computing device is a server (102), the method further comprising sending, to a client device (112), an instruction to display the at least part of the simplified first border and the at least part of the simplified second border on a display screen (118) of the client device (112).

Clause 8. The method of clause 7, wherein the instruction to display the at least part of the simplified first border and the at least part of the simplified second border on a display screen (118) of the client device (112) comprises an instruction to zoom a visual presentation of the at least part of the simplified first border and the at least part of the simplified second border.

Clause 9. The method of any one of clauses 1 to 5, wherein the computing device is a client device (112), the method further comprising rendering the at least part of the simplified first border and the at least part of the simplified second border on a display screen (118) of the client device (112).

Clause 10. The method of clause 9, wherein rendering the at least part of the simplified first border and the at least part of the simplified second border on the display screen (118) of the client device (112) is rendering scaled visual presentation of the at least part of the simplified first border and the at least part of the simplified second border.

Clause 11. The method of any one of clauses 1 to 2, wherein the first graphical object (202) and the second graphical object (204) are three-dimensional objects, and wherein the first original border portion (2022) and the second original border portion (2042) are curving surfaces.

Clause 12. A computing device (102, 112) for generating a simplified first border of a first graphical object (202) and a simplified second border of a second graphical object (204), both the first graphical object (202) and the second graphical object (204) having respectively a first original border and a second original border, the first original border and the second original border being defined by their respective coordinates, the computing device (102, 112) comprising a processor (108, 116) and an information storage medium (104, 114) storing instructions that, when executed by the processor (108, 116), configure the computing device (102, 112) to:
receive instruction to generate the simplified first border and the simplified second border;
detect, by comparing coordinates of the first graphical object (202) and the second graphical object (204), that a first original border portion (2022) and a second original border portion (2042) are located in close proximity within a predetermined maximal distance;
select a first point (402, 2024) and a second point (404, 2044), the first point (402, 2024) being located on the first original border portion (2022), and the second point (404, 2044) being located on the second original border portion (2042);
generate the simplified first border and the simplified second border comprising correspondingly a first simplified border portion and a second simplified border portion, by applying a single simplification rule both to the first original border portion (2022) and to the second original border portion (2042), such that:
   the first point (402, 2024) is located on the first simplified border portion, and
   the second point (404, 2044) is located on the second simplified border portion.

Clause 13. The computing device (102, 112) of clause 12, wherein selecting the first point (402) and the second point (404) is performed such that a distance between the first point (402) and the second point (404) is a shortest distance between the first original border portion (2022) and the second original border portion (2042).

Clause 14. The computing device (102, 112) of clause 12, wherein
the first original border portion (2022) comprises two extreme points defining a beginning and an end of the first original border portion (2022), and the second original border portion (2042) comprises two extreme points defining a beginning and an end of the second original border portion (2042); and wherein
selecting the first point (2024) and the second point (2044) is performed such that:
   the first point (2024) is an extreme point of the first original border portion (2022) define the beginning of the first original border portion (2022), and
   the second point (2044) is an extreme point of the second original border portion (2042) define the beginning of the second original border portion (2042), and
   the first point (2024) and the second point (2044) are located one in front of another, such that if all four extreme points (2024, 2026, 2044, 2046) consisting of two extreme points (2024, 2026) of the first original border portion (2022) define the beginning and the end of the first original border portion (2022) and two extreme points (2044, 2046) of the second original border portion (2042) define the beginning and the end of the second original border portion (2042), are connected by imaginary straight edges (702, 704, 706, 708, 710, 712), an imaginary straight edge (702) connect the first point (2024) and the second point (2044) is not crossed by any other one of said imaginary straight edges (704, 706, 708, 710, 712).

Clause 15. The computing device (102, 112) of clause 12, wherein the instructions further configure the server (102) to:
select a third point (2026) and a fourth point (2046), the third point (2026) being located on the first original border portion (2022) and the four point (2046) being located on the second original border portion (2042),
wherein:
   (i) selecting the first point (2024) and the third point (2026) is performed such that the first point (2024) and the third point (2026) are extreme points of the first original border portion (2022) defining a beginning and the end of the first original border portion (2022), and
   (ii) selecting the second point (2044) and the four point (2046) is executed such that the second point (2044) and the fourth point (2046) are extreme points of the second original border portion (2042) defining a beginning and an end of the second original border portion (2042);
and wherein:
   generating the simplified first border and the simplified second border comprising correspondingly the first simplified border portion and the second simplified border portion, is performed such that:
      the first point (2024) and the third point (2026) are located on the first simplified border portion, and
      the second point (2044) and the fourth point (2046) are located on the second simplified border portion.

Clause 16. The computing device (102, 112) of any one of clauses 12 to 15, wherein
the first original border portion (2022) comprises sections consecutively connect plurality of vertexes (2024, 2028, 2030, 2032, 2034, 2026) of the first original border portion (2022),
the second original border portion (2042) comprises sections consecutively connecting plurality of vertexes (2044, 2048, 2050, 2052, 2054, 2046) of the second original border portion (2042); and wherein
the single simplification rule comprises reducing number of vertexes of the first original border portion (2022) and number of vertexes of the second original border portion (2042).

Clause 17. The computing device (102, 112) of any one of clauses 12 to 16, wherein the computing device is any one, selected from: a server (102), and a client device (112).

Clause 18. The computing device (102) of any one of clauses 12 to 16, wherein the computing device is a server (102), and wherein the instructions further configure the server (102) to send, to a client device (112), an instruction to display the at least part of the simplified first border and the at least part of the simplified second border on a display screen (118) of the client device (112).

Clause 19. The computing device (102) of clause 18, wherein the instruction to display the at least part of the simplified first border and the at least part of the simplified second border on a display screen (118) of the client device (112) comprises an instruction to zoom a visual presentation of the at least part of the simplified first border and the at least part of the simplified second border.

Clause 20. The computing device (112) of any one of clauses 12 to 16, wherein the computing device is a client device (112), and wherein the instructions further configure the client device (112) to render the at least part of the simplified first border and the at least part of the simplified second border on a display screen (118) of the client device (112).

Clause 21. The computing device (112) of clause 20, wherein rendering the at least part of the simplified first border and the at least part of the simplified second border on the display screen (118) of the client device (112) is rendering scaled visual presentation of the at least part of the simplified first border and the at least part of the simplified second border.

Clause 22. The computing device (102, 112) of any one of clauses 12 to 13, wherein the first graphical object (202) and the second graphical object (204) are three-dimensional objects, and wherein the first original border portion (2022) and the second original border portion (2042) are curving surfaces.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for generating a simplified first border of a first graphical object and a simplified second border of a second graphical object, both the first graphical object and the second graphical object having respectively a first original border and a second original border, the first original border and the second original border being defined by their respective coordinates, the first original border comprising a first original border portion, the second original border comprising a second original border portion, the method executable on a computing device, the method comprising:
receiving an instruction to generate the simplified first border and the simplified second border;
detecting, by comparing coordinates of the first graphical object and the second graphical object, that the first original border portion and the second original border portion are located in close proximity within a predetermined maximal distance;
selecting a first point and a second point, the first point being located on the first original border portion and the second point being located on the second original border portion, the selecting being based on the first point and the second point being the closest points between each other from the first original border and the second original border, respectively;
using fixed first point and applying a single simplification rule to the first original border, generating the simplified first border, the simplified first border comprising a first simplified border portion;
using fixed second point and applying the single simplification rule to the second original border, generating the simplified second border, the simplified second border comprising a second simplified border portion;
the generating the simplified first border and the generating the simplified second border being executed such that:
the first point is located on the first simplified border portion, and
the second point is located on the second simplified border portion.

2. The method of claim 1, wherein selecting the first point and the second point is performed such that a distance between the first point and the second point is a shortest distance between the first original border portion and the second original border portion.

3. The method of claim 1, wherein the first original border portion comprises two extreme points defining a beginning and an end of the first original border portion, and the second original border portion comprises two extreme points defining a beginning and an end of the second original border portion; and wherein selecting the first point and the second point is performed such that:
the first point is an extreme point of the first original border portion defining the beginning of the first original border portion, and
the second point is an extreme point of the second original border portion defining the beginning of the second original border portion, and
the first point and the second point are located one in front of another, such that if all four extreme points consisting of two extreme points of the first original border portion defining the beginning and the end of the first original border portion and two extreme points of the second original border portion defining the beginning and the end of the second original border portion , are connected by imaginary straight edges , an imaginary straight edge connecting the first point and the second point is not crossed by any other one of said imaginary straight edges.

4. The method of claim 1, further comprising:
selecting a third point and a fourth point, the third point being located on the first original border portion and the fourth point being located on the second original border portion, wherein:
(i) selecting the first point and the third point is performed such that the first point and the third point are extreme points of the first original border portion defining a beginning and an end of the first original border portion, and
(ii) selecting the second point and the four point is executed such that the second point and the fourth point are extreme points of the second original border portion defining a beginning and an end of the second original border portion; and
wherein:
generating the simplified first border and the simplified second border comprising correspondingly the first simplified border portion and the second simplified border portion, is performed such that:
the first point and the third point are located on the first simplified border portion, and
the second point and the fourth point are located on the second simplified border portion.

5. The method of claim 1, wherein
the first original border portion comprises sections consecutively connecting plurality of vertexes of the first original border portion,
the second original border portion comprises sections consecutively connecting plurality of vertexes of the second original border portion; and wherein
the single simplification rule comprises reducing number of vertexes of the first original border portion and number of vertexes of the second original border portion.

6. The method of claim 1, wherein the computing device is any one, selected from: a server, and a client device.

7. The method of claim 1, wherein the computing device is a server, the method further comprising sending, to a client device, an instruction to display the at least part of the simplified first border and the at least part of the simplified second border on a display screen of the client device.

8. The method of claim 7, wherein the instruction to display the at least part of the simplified first border and the at least part of the simplified second border on a display screen of the client device comprises an instruction to zoom a visual presentation of the at least part of the simplified first border and the at least part of the simplified second border.

9. The method of claim 1, wherein the computing device is a client device, the method further comprising rendering the at least part of the simplified first border and the at least part of the simplified second border on a display screen of the client device.

10. The method of claim 9, wherein rendering the at least part of the simplified first border and the at least part of the simplified second border on the display screen of the client device is rendering scaled visual presentation of the at least part of the simplified first border and the at least part of the simplified second border.

11. The method of claim 1, wherein the first graphical object and the second graphical object are three-dimensional objects, and wherein the first original border portion and the second original border portion are curving surfaces.

12. A computing device for generating a simplified first border of a first graphical object and a simplified second border of a second graphical object , both the first graphical object and the second graphical object having respectively a first original border and a second original border, the first original border and the second original border being defined by their respective coordinates, the computing device comprising a processor and an information storage medium storing instructions that, when executed by the processor, configure the computing device to:
receive an instruction to generate the simplified first border and the simplified second border;
detect, by comparing coordinates of the first graphical object and the second graphical object, that a first original border portion and a second original border portion are located in close proximity within a predetermined maximal distance;
select a first point and a second point, the first point being located on the first original border portion , and the second point being located on the second original border portion , where selection is based on the first point and the second point (being the closest points between each other from the first original border and the second original border, respectively;
use fixed first point and apply a single simplification rule to the first original border to generate the simplified first border, the simplified first border comprising a first simplified border portion;
use fixed second point and apply the single simplification rule to the second original border to generate the simplified second border, the simplified second border comprising a second simplified border portion;
generate the simplified first border and generate the simplified second border, such that:
the first point is located on the first simplified border portion, and
the second point is located on the second simplified border portion.

13. The computing device of claim 12, wherein selecting the first point and the second point is performed such that a distance between the first point and the second point is a shortest distance between the first original border portion and the second original border portion.

14. The computing device of claim 12, wherein the first original border portion comprises two extreme points defining a beginning and an end of the first original border portion, and the second original border portion comprises two extreme points defining a beginning and an end of the second original border portion; and wherein selecting the first point and the second point is performed such that:
the first point is an extreme point of the first original border portion define the beginning of the first original border portion, and
the second point is an extreme point of the second original border portion define the beginning of the second original border portion, and
the first point and the second point are located one in front of another, such that if all four extreme points consisting of two extreme points of the first original border portion define the beginning and the end of the first original border portion—and two extreme points of the second original border portion define the beginning and the end of the second original border portion, are connected by imaginary straight edges , an imaginary straight edge connect the first point and the second point is not crossed by any other one of said imaginary straight edges.

15. The computing device of claim 12, wherein the instructions further configure the server to:
select a third point and a fourth point, the third point being located on the first original border portion and the fourth point being located on the second original border portion,
wherein:
(i) selecting the first point and the third point is performed such that the first point and the third point are extreme points of the first original border portion defining a beginning and the end of the first original border portion, and
(ii) selecting the second point and the four point is executed such that the second point and the fourth point are extreme points of the second original border portion defining a beginning and an end of the second original border portion;
and wherein:
generating the simplified first border and the simplified second border comprising correspondingly the first simplified border portion and the second simplified border portion, is performed such that:
the first point and the third point are located on the first simplified border portion, and
the second point and the fourth point are located on the second simplified border portion.

16. The computing device of claim 12, wherein
the first original border portion comprises sections consecutively connect plurality of vertexes of the first original border portion,
the second original border portion comprises sections consecutively connecting plurality of vertexes of the second original border portion; and wherein
the single simplification rule comprises reducing number of vertexes of the first original border portion and number of vertexes of the second original border portion.

17. The computing device of claim 12, wherein the computing device is any one, selected from: a server, and a client device.

18. The computing device of claim 12, wherein the computing device is a server, and wherein the instructions further configure the server to send, to a client device, an instruction to display the at least part of the simplified first border and the at least part of the simplified second border on a display screen of the client device.

19. The computing device of claim 18, wherein the instruction to display the at least part of the simplified first border and the at least part of the simplified second border on a display screen of the client device comprises an instruction to zoom a visual presentation of the at least part of the simplified first border and the at least part of the simplified second border.

20. The computing device of claim 12, wherein the computing device is a client device , and wherein the instructions further configure the client device to render the at least part of the simplified first border and the at least part of the simplified second border on a display screen of the client device.

21-22. (canceled)
